(19) United States
(12) Patent Application Publication
(10) Pub. No.: US 2014/0092988 A1
(43) Pub. Date: Apr. 3, 2014

(54) SYSTEMS AND METHODS FOR REFERENCE PICTURE SET EXTENSION

(71) Applicant: Sachin G. Deshpande, Camas, WA (US)

(72) Inventor: Sachin G. Deshpande, Camas, WA (US)

(73) Assignee: Sharp Laboratories of America, Inc., Camas, WA (US)

(21) Appl. No.: 13/631,712

(22) Filed: Sep. 28, 2012

(51) Int. Cl. H04N 7/26

(52) U.S. Cl. 375/240.26; 375/E07.2

(57) ABSTRACT

A method for sending information by an electronic device is described. The method includes creating reference picture set (RPS) information based on a coding structure. The method also includes determining whether to signal RPS extension information. The method additionally includes creating the RPS extension information if it is determined to signal RPS extension information. The method further includes sending the RPS extension information if it is determined to signal RPS extension information.

### TECHNICAL FIELD

The present disclosure relates generally to electronic devices. More specifically, the present disclosure relates to systems and methods for reference picture set (RPS) extension.

### BACKGROUND

Electronic devices have become smaller and more powerful in order to meet consumer needs and to improve portability and convenience. Consumers have become dependent upon electronic devices and have come to expect increased functionality. Some examples of electronic devices include desktop computers, laptop computers, cellular phones, smart phones, media players, integrated circuits, etc.

Some electronic devices are used for processing and displaying digital media. For example, portable electronic devices now allow for digital media to be consumed at almost any location where a consumer may be. Furthermore, some electronic devices may provide download or streaming of digital media content for the use and enjoyment of a consumer.

The increasing popularity of digital media has presented several problems. For example, efficiently representing high-quality digital media for storage, transmittal and playback presents several challenges. As can be observed from this discussion, systems and methods that represent digital media more efficiently may be beneficial.

### BRIEF DESCRIPTION OF THE DRAWINGS

FIG. 1 is a block diagram illustrating an example of one or more electronic devices in which systems and methods for reference picture set extension may be implemented;

FIG. 2 is a flow diagram illustrating one configuration of a method for sending information by an electronic device;

FIG. 3 is a flow diagram illustrating one configuration of a method for receiving information by an electronic device;

FIG. 4 is a flow diagram illustrating a more detailed configuration of a method for sending information by an electronic device;

FIG. 5 is a flow diagram illustrating a more detailed configuration of a method for receiving information by an electronic device;

FIG. 6 is a block diagram illustrating two examples of a sequence parameter set in accordance with the systems and methods disclosed herein;

FIG. 7 is a block diagram illustrating two examples of a slice header in accordance with the systems and methods disclosed herein;

FIG. 8 is a block diagram illustrating one configuration of an encoder on an electronic device;

FIG. 9 is a block diagram illustrating one configuration of a decoder on an electronic device;

FIG. 10 illustrates various components that may be utilized in a transmitting electronic device;

FIG. 11 is a block diagram illustrating various components that may be utilized in a receiving electronic device;

FIG. 12 is a block diagram illustrating one configuration of an electronic device in which systems and methods for reference picture set extension may be implemented; and

FIG. 13 is a block diagram illustrating another configuration of an electronic device in which systems and methods for reference picture set extension may be implemented.

### DETAILED DESCRIPTION

A method for sending information by an electronic device is described. The method includes creating reference picture set (RPS) information based on a coding structure. The method also includes determining whether to signal RPS extension information. The method further includes creating the RPS extension information if it is determined to signal RPS extension information. The method additionally includes sending the RPS extension information if it is determined to signal RPS extension information.

The method may also include generating an extension flag or extension indicator. The extension flag or extension indicator may indicate the presence of the RPS extension information if it is determined to signal RPS extension information. The extension flag may be at least one of an RPS extension flag and a short-term reference picture set (STRPS) extension flag.

The RPS extension information may include one or more layer identifiers. The RPS extension information may include a layer identifier for each picture in a reference picture set. The RPS extension information may include a layer identifier for one or more selected pictures in a reference picture set. In some configurations or cases, the RPS extension information may additionally or alternatively include other data, which may help in identifying and/or locating the picture as one of the pictures in the decoded picture buffer. The signal and the RPS extension information may be sent in at least one of a Sequence Parameter Set (SPS), a Video Parameter Set (VPS), a Picture Parameter Set (PPS), a slice header and other normative part of the bitstream.

A method for receiving information by an electronic device is also described. The method includes obtaining reference picture set (RPS) information. The method also includes obtaining an extension flag or extension indicator. The method additionally includes determining whether RPS extension information is present based on the extension flag. The method further includes obtaining RPS extension information if RPS extension information is present.

The RPS extension information may include one or more layer identifiers. The RPS extension information may include a layer identifier for each picture in a reference picture set. The RPS extension information may include a layer identifier for one or more selected pictures in a reference picture set. In some configurations or cases, the RPS extension information may additionally or alternatively include other data, which may help in identifying and/or locating a picture as one of the pictures in the decoded picture buffer.

The extension flag or extension indicator may be included in at least one of a Sequence Parameter Set (SPS), a Video Parameter Set (VPS), a Picture Parameter Set (PPS), a slice header and other normative part of the bitstream. Additionally, the RPS extension information may be included in at least one of a Sequence Parameter Set (SPS), a Video Parameter Set (VPS), a Picture Parameter Set (PPS), a slice header and other normative part of the bitstream.

An electronic device for sending information is also described. The electronic device includes a processor and memory in electronic communication with the processor. The electronic device creates reference picture set (RPS) information based on a coding structure. The electronic device determines whether to signal RPS extension information. The electronic device creates the RPS extension information if it is determined to signal RPS extension information. The electronic device also sends the RPS extension information if it is determined to signal RPS extension information.

An electronic device for receiving information is also described. The electronic device includes a processor and memory in electronic communication with the processor. The electronic device obtains reference picture set (RPS) information. The electronic device obtains an extension flag. The electronic device determines whether RPS extension information is present based on the extension flag. The electronic device also obtains RPS extension information if RPS extension information is present.

The systems and methods disclosed herein describe approaches for RPS extension. For example, some configurations described herein include devices and methods for creating RPS extension information with RPS information. Further, some of the described devices and approaches may generate a RPS extension flag.

A RPS is a set of reference pictures associated with a picture. A RPS may include reference pictures that are prior to the associated picture in decoding order that may be used for inter prediction of the associated picture and for any picture following the associated picture in decoding order. A RPS describes one or more reference pictures in the decoded picture buffer (DPB). This may be accomplished in the slice header of each picture.

A DPB may store reconstructed (e.g., decoded) pictures at a decoder. These stored pictures may then be used, for example, in an inter-prediction mechanism. When pictures are decoded out of order, the pictures may be stored in the DPB so they can be displayed later in order. Also, a picture in the DPB may be associated with a picture order count (POC). The POC may be a variable that is associated with each encoded picture. The POC may have a value that increases with increasing picture position in an output order. In other words, the POC may be used by the decoder to deliver the pictures in the correct order for display. The POC may also be used for identification of reference pictures during reference picture list construction and decoded reference picture marking.

In some configurations, reference pictures are referenced using either relative (e.g., delta) referencing (using a delta_POC and a POC_current, for example) or absolute referencing (using the POC, for example). For instance, the DPB may include a set of received pictures, which are decoded. A subset of these received pictures may use relative (e.g., delta) referencing and the remaining received pictures may use absolute referencing. It should be noted that one or more of the configurations of buffer descriptions and syntaxes described herein may be implemented in combination with one or more of the approaches (e.g., methods) described herein.

A RPS may include a list of information of all reference pictures that the decoder may keep. For example, this information may be stored as a set of indexes called delta_POCs. A delta_POC may be used to calculate the POC of a reference picture. By using the current POC of the picture to be decoded and the delta_POC of a reference picture, the reference picture may be located in a relative manner.

The systems and methods described herein may extend the basic RPS as detailed in Benjamin Bross et al., “High efficiency video coding (HEVC) text specification draft 8,” JCTVC-J1003_d7, Stockholm, July 2012 (hereinafter “JCTVC-J1003”). For example, syntax and semantics included in the systems and methods described herein may extend the basic RPS in JCTVC-J1003. Additionally, the systems and methods described herein may extend RPS signaling for scalable extensions currently under call for proposal stage as detailed in A. Luthra, “Joint Preliminary Call for Proposals on Scalable Video Coding Extensions of High Efficiency Video Coding (HEVC),” ISO/IEC JTC1/SC29/WG11 M25345, Stockholm, July, 2012 (hereinafter “Scalable Video”).

A benefit of the systems and methods described herein is simplifying the signaling of additional syntax elements related to reference picture sets. For example, under the approach of JCTVC-J1003, reference picture sets may be signaled in a sequence parameter set (SPS) and/or in slice headers. However, if additional syntax elements need to be signaled for RPS in a future extension of HEVC (e.g., for a scalable extension of HEVC), then using the available mechanisms, as detailed in JCTVC-J1003, may be problematic. For instance, additional syntax may need to be defined in two places: one in a SPS extension and another in a slice header extension. The syntax for these two extensions may be different because the slice header extension syntax is defined differently than SPS extension syntax.

For example, under JCTVC-J1003, if a SPS extension mechanism is used to signal new extension related syntax elements, then a decoder needs to parse additional syntax elements after parsing short_term_ref pic_set, which includes the RPS-related syntax elements (e.g., delta_POC elements, used_by_curr_pic elements). After parsing short_term_ref pic_set, the decoder may then reach and obtain other RPS syntax elements related to RPS extension (e.g., layer_id elements). This approach is complicated because the decoder would need to keep track of the num_negative_pics and the num_positive_pics for each RPS in the num_short_term_ref pic_sets, which represents the total number of RPSs.

The systems and methods described herein define syntax elements in a RPS extension to provide RPS extensibility. For example, according to the teachings of the systems and methods described herein, all syntax elements related to RPS (e.g., delta_POC elements, used_by_curr_pic elements and layer_id elements) may be included together.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

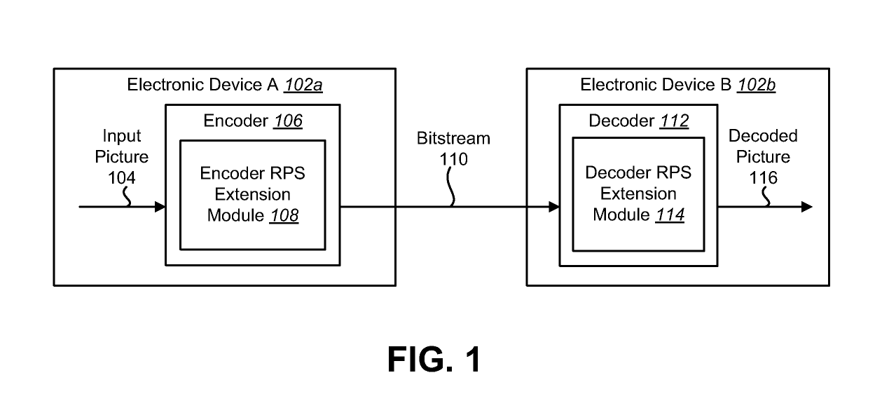

FIG. 1 is a block diagram illustrating an example of one or more electronic devices 102a-b in which systems and methods for reference picture set extension may be implemented. In this example, electronic device A 102a and electronic device B 102b are illustrated. However, it should be noted that one or more of the features and functionality described in relation to electronic device A 102a and electronic device B 102b may be combined into a single electronic device in some configurations.

Electronic device A 102a may include an encoder 106. Each of the elements included within electronic device A 102a (e.g., the encoder 106 and encoder RPS extension module 108) may be implemented in hardware, software or a combination of both.

Electronic device A 102a may obtain an input picture 104. In some configurations, the input picture 104 may be captured on electronic device A 102a using an image sensor, retrieved from memory or received from another electronic device.

The encoder 106 may encode the input picture 104 to produce encoded data. For example, the encoder 106 may encode a series of input pictures 104 (e.g., video). In one configuration, the encoder 106 may be a HEVC encoder. The encoded data may be included in a bitstream 110. The encoder 106 may generate overhead signaling based on the input picture 104.

The encoder RPS extension module 108 may create RPS extension information and additionally or alternatively generate a RPS extension flag. For example, the encoder RPS extension module 108 may determine whether to signal RPS extension information. The RPS extension information may be based on RPS information that may be created. The encoder RPS extension module 108 may further generate a RPS extension flag if RPS extension information is present. More detail is given below. In some configurations, the encoder RPS extension module 108 may send or otherwise share RPS extension information and the RPS extension flag with one or more electronic devices. In one example, electronic device A 102a may send RPS extension information and one or more RPS extension flags to electronic device B 102b. One benefit of creating RPS extension information may include reducing operations performed on one or more pictures when processing one or more pictures in a bitstream 110.

The encoder 106 may produce a bitstream 110. The bitstream 110 may include encoded data based on the input picture 104. In one example, the bitstream 110 may include encoded picture data. In some configurations, the bitstream 110 may also include overhead data, such as SPS information, PPS information, VPS information, slice header information, etc.

The bitstream 110 may be provided to a decoder 112. In one example, the bitstream 110 may be transmitted to electronic device B 102b using a wired or wireless link. In some cases, this may be done over a network, such as the Internet, Local Area Network (LAN) or other type of network for communicating between devices. As illustrated in FIG. 1, the decoder 112 may be implemented on electronic device B 102b separately from the encoder 106 on electronic device A 102a. It should be noted that in some configurations, the encoder 106 and decoder 112 may be implemented on the same electronic device. In an implementation where the encoder 106 and decoder 112 are implemented on the same electronic device, for instance, the bitstream 110 may be made available to the decoder in a variety of ways. For example, the bitstream 110 may be provided over a bus to the decoder 112 or stored in memory for retrieval by the decoder 112.

The decoder 112 may be implemented in hardware, software or a combination of both. In one configuration, the decoder 112 may be a HEVC decoder. The decoder 112 may obtain (e.g., receive) the bitstream 110. The decoder 112 may generate one or more decoded pictures 116 based on the bitstream 110. A decoded picture 116 may be displayed, played back, stored in memory and/or transmitted to another device, etc.

The decoder 112 may include a decoder RPS extension module 114. The decoder RPS extension module 114 may enable electronic device B 102b to identify whether RPS extension information is present in a bitstream 110. For example, the decoder RPS extension module 114 may determine whether a RPS extension information is present based on whether the bitstream 110 includes a RPS extension flag. The decoder RPS extension module 114 is described in greater detail below.

Electronic device B 102b may also perform one or more operations on the bitstream 110. In one example, an operation or process performed on the bitstream 110 may be based on whether RPS extension information is present or not. In some configurations, the decoder 112 or other element on electronic device B 102b may perform the operation on the bitstream 110.

In some configurations, electronic device B 102b may output a decoded picture 116. In one example, the decoded picture 116 may be transmitted to another device or back to electronic device A 102a. In one configuration, the decoded picture 116 may be stored or otherwise maintained on electronic device B 102b. In another example, electronic device B 102b may display the decoded picture 116. In other configurations, the decoded picture 116 may include elements of the input picture 104 with different properties based on the encoding and other operations performed on the bitstream 110. In some configurations, the decoded picture 116 may be included in a picture stream with a different resolution, format, specifications or other attribute from the input picture 104.

It should be noted that in some configurations or instances, the bitstream 110 may be provided to electronic device B 102b. For example, the electronic device B 102b may include a decoder 112 that may receive the bitstream 110 sent from electronic device A 102a. Alternatively, the bitstream 110 may be relayed to the electronic device B 102b through an intervening device. For example, the intervening device may receive the bitstream 110 and relay it to electronic device B 102b. In some cases or configurations, the intervening device may include a decoder RPS extension module 114 to determine whether RPS extension information is present in a bitstream 110.

It should also be noted that one or more of the elements or parts thereof included in the electronic device(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application specific integrated circuit (ASIC), a large-scale integrated circuit (LSI) or integrated circuit, etc.

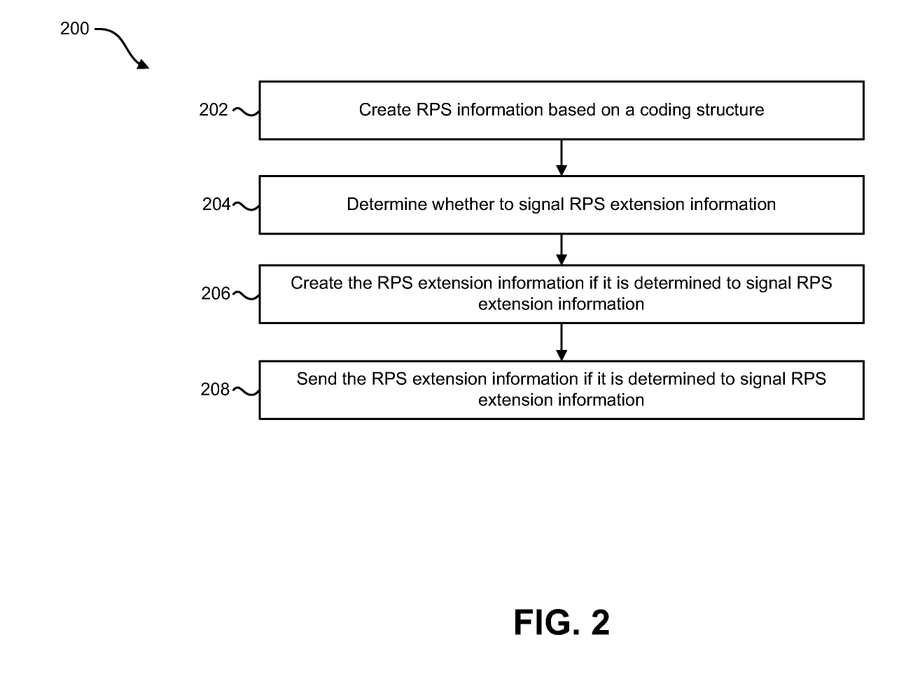

FIG. 2 is a flow diagram illustrating one configuration of a method 200 for sending information by an electronic device 102. The information sent by the electronic device 102 may comprise RPS extension information. For example, the electronic device 102 may create 202 RPS information based on a coding structure. In one configuration, the RPS information may be created 202 by an encoder 106. The RPS information may include delta_POC elements and a used_by_curr_pic flag. The RPS information that may be created 202 may depend on a coding structure. The coding structure refers to how the frames in the bitstream 110 are coded. In particular, the coding structure indicates whether one or more frames are reference frames for one or more other frames.

The electronic device 102 may determine 204 whether to signal RPS extension information. In one case, the RPS extension information may not be signaled when sending a bitstream 110 conforming to JCTVC-J1003, although in this case the RPS extension flag may still be signaled. In another case, the RPS extension information may always be signaled when sending a bitstream 110 conforming to an HEVC extension specification. In yet another case, the RPS extension information may be signaled when sending a bitstream 110 conforming to an HEVC extension specification when there are more than one base layers in the bitstream 110 and if the coding structure is such that at least one picture uses both a base and one or more enhancement layer pictures as a reference picture.

The electronic device 102 may create 206 the RPS extension information if it is determined to signal RPS extension information. For example, the RPS extension information may include one or more layer identifiers (e.g., layer_id). The one or more layer identifiers may be used in conjunction with a delta_POC element to identify the reference picture in a RPS.

One example of RPS extension syntax and semantics in accordance with the systems and methods disclosed herein is illustrated in Table 1. This example relates to a short-term reference picture set. In some known configurations, such as JCTVC-J1003, the RPS-related syntax and semantics are described. The systems and methods disclosed herein may describe modifications to the syntax and semantics presented in JCTVC-J1003. The changes due to the prior approach are given in bold text in Table 1.

TABLE 1

```
short_term_ref_pic_set( idx ) {
  inter_ref_pic_set_prediction_flag
  if( inter_ref_pic_set_prediction_flag ) {
    if( idx = = num_short_term_ref_pic_sets )
      delta_idx_minus1
    delta_rps_sign
    abs_delta_rps_minus1
    for( j = 0; j <= NumDeltaPocs[ RIdx ]; j++ ) {
      used_by_curr_pic_flag[ j ]
      if( !used_by_curr_pic_flag[ j ] )
        use_delta_flag[ j ]
    }
  }
  else {
    num_negative_pics
    num_positive_pics
    for( i = 0; i < num_negative_pics; i++ ) {
      delta_poc_s0_minus1[i]
      used_by_curr_pic_s0_flag[i]
    }
    for( i = 0; i < num_positive_pics; i++ ) {
      delta_poc_s1_minus1[i]
      used_by_curr_pic_s1_flag[i]
    }
  }
  rps_extension_flag
  if( rps_extension_flag )
    while( more_rbsp_data( ) )
      rps_extension_data_flag
}
```

A rps_extension_flag equal to 0 may indicate that no rps_extension_data_flag syntax elements are present in the short-term reference picture set raw byte sequence payload (RBSP) syntax structure. The rps_extension_flag may be equal to 0 in bitstreams conforming to JCTVC-J1003. The value of 1 for rps_extension_flag is reserved for future use. In some configurations, decoders may ignore all data that follow the value 1 for a rps_extension_flag in a network abstraction layer (NAL) unit.

A rps_extension_data_flag may have any value. The value of the rps_extension_data_flag may not affect decoder conformance to profiles specified in JCTVC-J1003.

A num_short_term_ref_pic_sets may be a syntax element from the active picture parameter set. A num_negative_pics may specify the number of the delta_poc_s0_minus1 [i] and used_by_curr_pic_s0_flag[i] syntax elements. A num_positive_pics may specify the number of the following delta_poc_s 1_minus 1[i] and used_by_curr_pic_s1_flag1 [i] syntax elements.

A delta_idx_minus1 plus 1 may specify the difference between the index of the reference picture set of the current picture and the index of the reference picture set used for inter reference picture set prediction. The value of delta_idx_minus 1 may be in the range of 0 to idx−1, inclusive. When delta_idx_minus1 is not present, it may be inferred to be equal to 0.

The variable RIdx may be derived as follows. RIdx=idx−(delta_idx_minus1+1).

A delta_rps_sign and abs_delta_rps_minus1 together may specify the value of the variable DeltaRPS as DeltaRPS=(1−2*delta_rps_sign)*(abs_delta_rps_minus1+1). The variable DeltaRPS may represent the value to be added to picture order count difference values of the reference picture set used for inter reference picture set prediction to obtain the picture order count difference values of the current reference picture set.

A used_by_curr_pic_flag[j] equal to 0 may specify that the j-th picture is not used for reference by the current picture. A use_delta_flag[j] equal to 1 may specify that the j-th picture is included in the reference picture set of the current picture. A use_delta_flag[j] equal to 0 may specify that the j-th picture is not included in the reference picture set of the current picture. When use_delta_flag[j] is not present, its value may be inferred to be equal to 1.

An inter_ref_pic_set_prediction_flag equal to 1 may specify that the reference picture set of the current picture is predicted using another reference picture set in the active sequence parameter set. When idx is equal to 0, the value of inter_ref pic_set_prediction_flag may be equal to 0. When inter_ref pic_set_prediction_flag is equal to 1, the variables DeltaPocS0[idx][i], UsedByCurrPicS0[idx][i], and NumNegativePics[idx] may be derived as illustrated in Table 2.

```
TABLE 2
i = 0
for( j = NumPositivePics[ RIdx ] - 1; j >= 0; j- -) {
  dPoc = DeltaPocS1[ RIdx ][ j ] + DeltaRPS
  if( dPoc < 0 && use_delta_flag[ NumNegativePics[ RIdx ] + j ] ) {
    DeltaPocS0[ idx ][ i ] = dPoc
    UsedByCurrPicS0[idx][i++]=used_by_curr_pic_
    flag[ NumNegativePics[ RIdx ] + j ]
  }
}
if( DeltaRPS < 0 && use_delta_flag[ NumDeltaPocs[ RIdx ] ] ) {
  DeltaPocS0[ idx ][ i ] = DeltaRPS
  UsedByCurrPicS0[ idx ][ i++ ] = used_by_curr_pic_
  flag[ NumDeltaPocs[ RIdx ]]
}
for( j = 0; j < NumNegativePics[RIdx ]; j++) {
  dPoc = DeltaPocS0[ RIdx ][ j ] + DeltaRPS
  if( dPoc < 0 && use_delta_flag[ j ] ) {
    DeltaPocS0[ idx ][ i ] = dPoc
    UsedByCurrPicS0[ idx ][ i++ ] = used_by_curr_pic_flag[ j ]
  }
}
NumNegativePics[ idx ] = i
```

When inter_ref pic_set_prediction_flag is equal to 1, the variables DeltaPocS1[idx][i], UsedByCurrPicS1[idx][i], and NumPositivePics[idx] may be derived as illustrated in Table 3.

```
TABLE 3
i = 0
for( j = NumNegativePics[ RIdx ] - 1; j >= 0; j- -) {
  dPoc = DeltaPocS0[ RIdx ][ j ] + DeltaRPS
  if( dPoc > 0 && use_delta_flag[ j ]) {
    DeltaPocS1[ idx ][ i ] = dPoc
    UsedByCurrPicS1[ idx ][ i++] = used_by_curr_pic_flag[ j ]
  }
}
if( DeltaRPS > 0 && use_delta_flag[ NumDeltaPocs[ RIdx ] ] ) {
  DeltaPocS1[ idx ][ i ] = DeltaRPS
  UsedByCurrPicS1[ idx ][ i++ ] = used_by_curr_pic_
  flag[ NumDeltaPocs[ RIdx ] ]
}
for( j = 0; j < NumPositivePics[ RIdx ]; j++) {
  dPoc = DeltaPocS1[ RIdx ][ j ] + DeltaRPS
  if( dPoc > 0 && use_delta_flag[ NumNegativePics[ RIdx ] +j ] ) {
    DeltaPocS1[ idx ][ i ] = dPoc
    UsedByCurrPicS1[idx][i++] = used_by_curr_pic_
    flag[NumNegativePics[RIdx]+j]
  }
}
NumPositivePics[ idx ] = i
```

The variable NumDeltaPocs[idx] may be derived as follows. NumDeltaPocs[idx]=NumNegativePics[idx]+NumPositivePics[idx].

Another example of RPS extension syntax and semantics in accordance with the systems and methods disclosed herein is illustrated in Table 4. In this example, syntax and semantics for signaling RPSs for scalable extensions of HEVC are described. In some known configurations, such as Scalable Video, syntax and semantics are described for signaling RPSs for scalable extensions of HEVC. The systems and methods disclosed herein describe modifications to the syntax and semantics presented in Scalable Video. The changes to a known approach are given in bold text in Table 4.

TABLE 4

```
short_term_ref pic_set( idx ) {
  inter_ref_pic_set_prediction_flag
  if( inter_ref_pic_set_prediction_flag ) {
    if( idx = = num_short_term_ref pic_sets )
      delta_idx_minus1
    delta_rps_sign
    abs_delta_rps_minus1
    for( j = 0; j <= NumDeltaPocs[ RIdx ]; j++ ) {
      used_by_curr_pic_flag[ j ]
      if( !used_by_curr_pic_flag[ j ] )
        use_delta_flag[ j ]
    }
  }
  else {
    num_negative_pics
    num_positive_pics
    for( i = 0; i < num_negative_pics; i++ ) {
      delta_poc_s0_minus1[i]
      used_by_curr_pic_s0_flag[i]
    }
    for( i = 0; i < num_positive_pics; i++) {
      delta_poc_s1 _minus1[i]
      used_by_curr_pic_s1_flag[i]
    }
  }
  bit_equal_to_one
  rps_extension( )
  rps_extension_flag
  if( rps_extension_flag )
    while( more_rbsp_data( ) )
      rps_extension_data_flag
}
rps_extension( ) {
    for( i = 0; i < num_negative_pics; i++ ) {
      layer_id_s0[i]
    }
    for( i = 0; i < num_positive_pics; i++ ) {
      layer_id_s1 [i]
    }
}
```

A layer_id_s0[i] may specify the value of layer_id for the i-th reference picture. This value together with the value of delta_poc_s0_minus1[i] may be used to identify the reference picture. A layer_id_s1[i] may specify the value of layer_id for the i-th reference picture. This value together with the value of delta_poc_s1_minus1[i] may be used to identify the reference picture. A bit_equal_to_one may be a bit with a value of 1.

In one configuration, syntax elements layer_id_s0_minus1 [i] and layer_ids1_minus1[i] may be signaled by subtracting 1 from the layer_id value instead of the syntax elements layer_id_s0[i] and layer_id_s1[i]. In another configuration, in order to signal a RPS in which layer_id_s0[i] and layer_id_s1[i] are equal to 0 (e.g., base layer) for all the reference pictures included in the RPS, the rps_extension_flag may be set to 0 for signaling that corresponding RPS.

In one configuration, the RPS extension information may be signaled as part of a RPS extension raw byte sequence payload (RBSP). In other configurations, the RPS extension information may be signaled as part of one or more of a SPS extension RBSP (e.g., sps_extension RBSP), a VPS extension RBSP (e.g., vps_extension RBSP), a PPS extension RBSP (e.g., pps_extension RBSP) and a slice header RBSP (e.g., slice_header_extension RBSP). In some configurations, rbsp_trailing_bits( ) may be added after the new RPS extension syntax elements as illustrated in Table 5.

TABLE 5

```
...
  rps_extension_flag
  if( rps_extension_flag )
    while( more_rbsp_data( ) )
      rps_extension_data_flag
rbsp_trailing_bits( )
}
```

The more_rbsp_data( ) may be specified as follows. If there is no more data in the RBSP, the return value of more_rbsp_data( ) is equal to FALSE. Otherwise, the RBSP data is searched for the last (e.g., least significant, right-most) bit equal to 1 that is present in the RBSP. Given the position of this bit, which is the first bit (rbsp_stop_one_bit) of the rbsp_trailing_bits( ) syntax structure, the following may apply. If there is more data in an RBSP before the rbsp_trailing_bits( ) syntax structure, the return value of more_rbsp_data( ) is equal to TRUE. Otherwise, the return value of more_rbsp_data( ) is equal to FALSE.

A rps_extension_data_flag may have any value. Its value does not affect decoder conformance to profiles specified in this Specification.

The rbsp_trailing_bits( ) may be specified as illustrated in Table 6.

TABLE 6

```
rbsp_trailing_bits( ) {
  rbsp_stop_one_bit /* equal to 1 */
  while( !byte_aligned( ) )
    rbsp_alignment_zero_bit /* equal to 0 */
}
```

A rbsp_stop_one_bit may be equal to 1. A rbsp_alignment_zero_bit may be equal to 0.

The byte_aligned( ) may be specified as follows. If the current position in the bitstream is on a byte boundary (e.g., the next bit in the bitstream is the first bit in a byte), the return value of byte_aligned( ) is equal to TRUE. Otherwise, the return value of byte_aligned( ) is equal to FALSE.

It should be noted that although Table 3 and Table 4 show the RPS extension inside a short-term reference picture set, the systems and methods described herein (e.g., an extension mechanism) may be applied to any other reference picture set. For example, the systems and methods described herein may be applied to a long-term reference picture set. It should also be noted that the electronic device 102 may create 206 RPS extension information for one or more of the reference pictures that may be signaled by the RPS information. For example, the RPS extension information may include a layer identifier for each picture in a RPS. Alternatively, the RPS extension information may include a layer identifier for one or more selected pictures in a RPS.

The electronic device 102 may generate an extension flag in addition to or alternatively from creating 206 RPS extension information. For example, an RPS extension flag may indicate the presence of the RPS extension information if it is determined to signal RPS extension information. However, the RPS extension flag may indicate the absence of RPS extension information if it is determined not to signal RPS extension information. In one configuration, the RPS extension flag may be the variable rps_extension_flag described above. The extension flag could be alternatively referred to as an extension indicator. Therefore, the extension flag or extension indicator may be an indicator that conditions and additionally or alternatively indicates whether extension information is present.

In another configuration, the presence of the RPS extension information may be indicated based on a higher level flag sent in a parameter set (e.g., a sequence parameter set). For example, a short-term reference picture set (STRPS) extension flag may be conditioned upon and may additionally or alternatively indicate the presence of RPS extension information. In one configuration, the STRPS extension flag may be the variable strps_extension_present_flag. An example the higher level flag and semantics is illustrated in Table 7.

TABLE 7

```
seq_parameter_set_rbsp( ) ) {
  video_parameter_set_id
  sps_max_sub_layers_minus1
  sps_reserved_zero_bit
...
  strps_extension_present_flag
  vui_parameters_present_flag
  if( vui_parameters_present_flag )
...
```

A strps_extension_present_flag equal to 0 may specify that no short-term reference picture set extension syntax elements are present in the short-term reference picture set syntax. The strps_extension_present_flag may be equal to 0 in bitstreams conforming to JCTVC-J1003. The value of 1 for strps_extension_present_flag is reserved for future use.

A video_parameter_set_id may refer to the active video parameter set. A sps_max_sub_layers_minus1 plus 1 may specify the maximum number of temporal sub-layers that may be present in each coded video sequence referring to the sequence parameter set. The value of sps_max_sub_layers_minusl may be in the range of 0 to 6, inclusive.

A sps_reserved_zero_bit may be equal to 0 in bitstreams conforming to JCTVC-J1003. The value 1 for sps_reserved_zero_bit is reserved for future use. In some configurations, decoders may ignore the value of sps_reserved_zero_bit.

A vui_parameters_present_flag equal to 1 may specify that the vui_parameters( ) syntax structure is present. vui_parameters_present_flag equal to 0 may specify that the vui_parameters( ) syntax structure is not present.

In the case where the presence of the RPS extension information may be based on a higher level flag sent in a parameter set, the RPS extension syntax elements may be signaled when a strps_extension_present_flag has a value of 1. An example of signaling RPS extension syntax based on a higher level flag is shown in Table 8.

TABLE 8

```
short_term_ref_pic_set( idx ) {
  inter_ref_pic_set_prediction_flag
  if( inter_ref_pic_set_prediction_flag ) {
    if( idx = = num_short_term_ref_pic_sets )
      delta_idx_minus1
    delta_rps_sign
    abs_delta_rps_minus1
    for( j = 0; j <= NumDeltaPocs[ RIdx ]; j++) {
      used_by_curr_pic_flag[ j ]
      if( !used_by_curr_pic_flag[ j ])
        use_delta_flag[ j ]
    }
  }
  else {
    num_negative_pics
    num_positive_pics
    for( i = 0; i < num_negative_pics; i++ ) {
      delta_poc_s0_minus1[i]
      used_by_curr_pic_s0_flag[i]
    }
    for( i = 0; i < num_positive_pics; i++ ) {
      delta_poc_s1 _minus1[i]
      used_by_curr_pic_s1_flag[i]
    }
  }
if(strps_extension_present_flag) {
  rps_extension_flag
  if( rps_extension_flag )
    while( more_rbsp_data( ) )
      rps_extension_data_flag
  }
}
```

In one configuration, the extension flag may include the RPS extension flag. In another configuration, the extension flag may include the STRPS extension flag. In yet another configuration, the extension flag may include a combination of the RPS extension flag and the STRPS extension flag.

The electronic device 102 may send 208 the RPS extension information if it is determined to signal RPS extension information. For example, the electronic device 102 may include an encoder 106 that may produce a bitstream 110. The RPS extension information may be included in overhead data such as one or more of SPS information, VPS information, PPS information and a slice header information. In some configurations, one or both of the RPS information and the RPS extension flag may be included in the overhead data. The bitstream 110 may include the overhead data with one or more of the RPS information, RPS extension information and the RPS extension flag.

The bitstream 110 may include various restrictions related to RPS extensions. In one configuration, the reference picture set may consist of five lists of reference pictures; RefPicSetStCurrBefore, RefPicSetStCurrAfter, RefPicSetStFoll, RefPicSetLtCurr and RefPicSetLtFoll. There may be no picture included in RefPicSetStCurrBefore, RefPicSetStCurrAfter or RefPicSetLtCurr that has a layer_id greater than that of the current picture. Pictures with higher layer_id than current picture that are included in RefPicSetLtCurr, RefPicSetLtFoll, RefPicSetStCurrBefore, RefPicSetStCurrAfter or RefPicSetStFoll but are not present in the decoded picture buffer marked as “used for reference” may be ignored. Pictures with the same or a lower layer_id than that of the current picture that are included in RefPicSetLtCurr, RefPicSetLtFoll, RefPicSetStCurrBefore, RefPicSetStCurrAfter or RefPicSetStFoll, but are not present in the decoded picture buffer marked as “used for reference,” may be detected as lost.

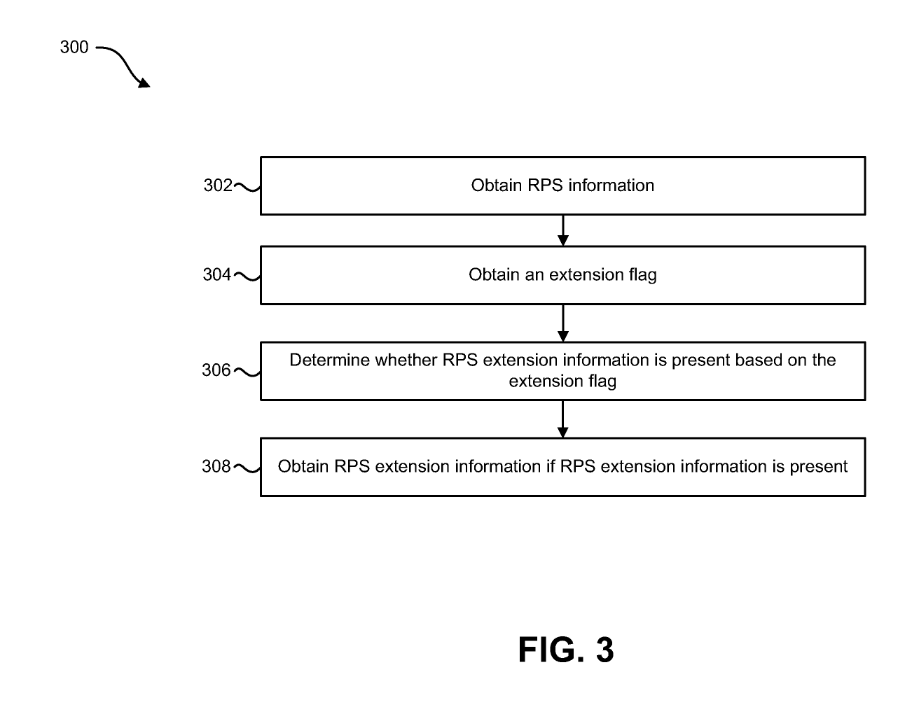

FIG. 3 is a flow diagram illustrating one configuration of a method 300 for receiving information by an electronic device 102. The electronic device 102 may obtain 302 RPS information. For example, the electronic device 102 may include a decoder 112 that may receive a bitstream 110. The bitstream 110 may include one or more of RPS information, RPS extension information and an extension flag. One or more of the RPS information, RPS extension information and extension flag may be included in overhead data such as SPS information, VPS information, PPS information and a slice header information. The decoder 112 may receive the bitstream 110 and may obtain 302 (e.g., extract) RPS information from the bitstream 110.

The electronic device 102 may obtain 304 an extension flag. In one configuration, the bitstream 110 may include a RPS extension flag. In another configuration, the bitstream 110 may include a STRPS extension flag. In yet another configuration, the bitstream 110 may include both the RPS extension flag and the STRPS extension flag.

The extension flag may be included in overhead data such as one or more of SPS information, VPS information, PPS information and a slice header information. The decoder 112 may receive the bitstream 110 and may obtain 304 the extension flag from the bitstream 110. The extension flag may condition and additionally or alternatively may indicate the presence or absence of RPS extension information as described above in connection with FIG. 2. In one configuration, the extension flag may be the variable rps_extension_flag described above. Additionally or alternatively, the extension flag may be the variable strps_extension_present_flag described above.

The electronic device 102 may determine 306 whether RPS extension information is present based on the extension flag. For example, the decoder 112 may assess the extension flag in order to determine 306 whether RPS extension information may be present in the bitstream 110.

The electronic device 102 may obtain 308 RPS extension information if RPS extension information is present. For example, if the extension flag indicates that RPS extension information is present, the decoder 112 may obtain 308 the RPS extension information from the bitstream 110. The RPS extension information may be included in overhead data such as one or more of SPS information, VPS information, PPS information and slice header information. The decoder 112 may receive the bitstream 110 and may obtain 308 RPS extension information from the bitstream 110. The RPS extension information may include one or more layer identifiers (e.g., layer_id) as described above in connection with FIG. 2. Upon obtaining 308 the RPS extension information, the decoder 112 may decode the RPS information and the RPS extension information.

It should be noted that the electronic device 102 may obtain 308 RPS extension information for one or more of the reference pictures that may be signaled by the RPS information. For example, the RPS extension information may include a layer identifier (e.g., layer_id) for each picture in a RPS. Alternatively, the RPS extension information may include a layer identifier for one or more selected pictures in a RPS.

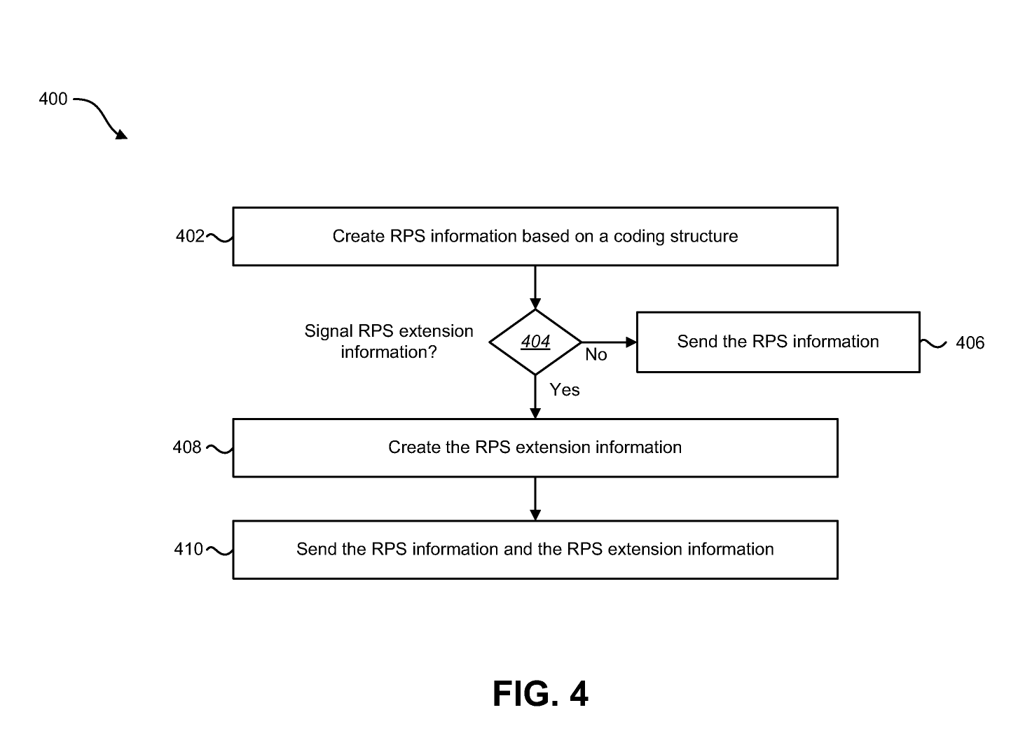

FIG. 4 is a flow diagram illustrating a more detailed configuration of a method 400 for sending information by an electronic device 102. For example, the electronic device 102 may create 402 RPS information based on a coding structure. This may be performed as described above in connection with FIG. 2.

The electronic device 102 may determine 404 whether to signal RPS extension information. In one case, the RPS extension information may not be signaled when sending a bitstream 110 conforming to JCTVC-J1003, although in this case the extension flag may still be signaled. In another case, the RPS extension information may always be signaled when sending a bitstream 110 conforming to an HEVC extension specification. In yet another case, the RPS extension information may be signaled when sending a bitstream 110 conforming to an HEVC extension specification when there are more than one base layers in the bitstream 110 and if the coding structure is such that at least one picture uses both a base and one or more enhancement layer pictures as a reference picture.

The electronic device 102 may send 406 the RPS information if it is determined not to signal RPS extension information. For example, the encoder 106 may send 406 the RPS information as part of a bitstream 110. The RPS information may include delta_POC elements and a used_by_curr_pic flag. In some configurations, the encoder 106 may generate and send an extension flag with the RPS information that may indicate that RPS extension information is not present. In one configuration, the encoder 106 may set rps_extension_flag equal to 0 to indicate that no RPS extension information is present.

The electronic device 102 may create 408 the RPS extension information if it is determined to signal RPS extension information. The RPS extension information may be created 408 as described above in connection with FIG. 2. RPS extension information may be created 408 for each picture in a RPS. Alternatively, RPS extension information may be created 408 for one or more selected pictures in a RPS.

The electronic device 102 may send 410 the RPS information and RPS extension information if it is determined to signal RPS extension information. For example, the encoder 106 may send 410 the RPS information and RPS extension information as part of the bitstream 110. The RPS extension information may include layer identifiers (e.g., layer_id). The layer identifiers may identify a layer in a RPS, and may identify a particular reference picture.

In some configurations, the encoder 106 may generate and send 410 an extension flag with the RPS information and RPS extension information. The extension flag may indicate that RPS extension information is present. In one configuration, the encoder 106 may set rps_extension_flag equal to 1 to indicate that RPS extension information is present.

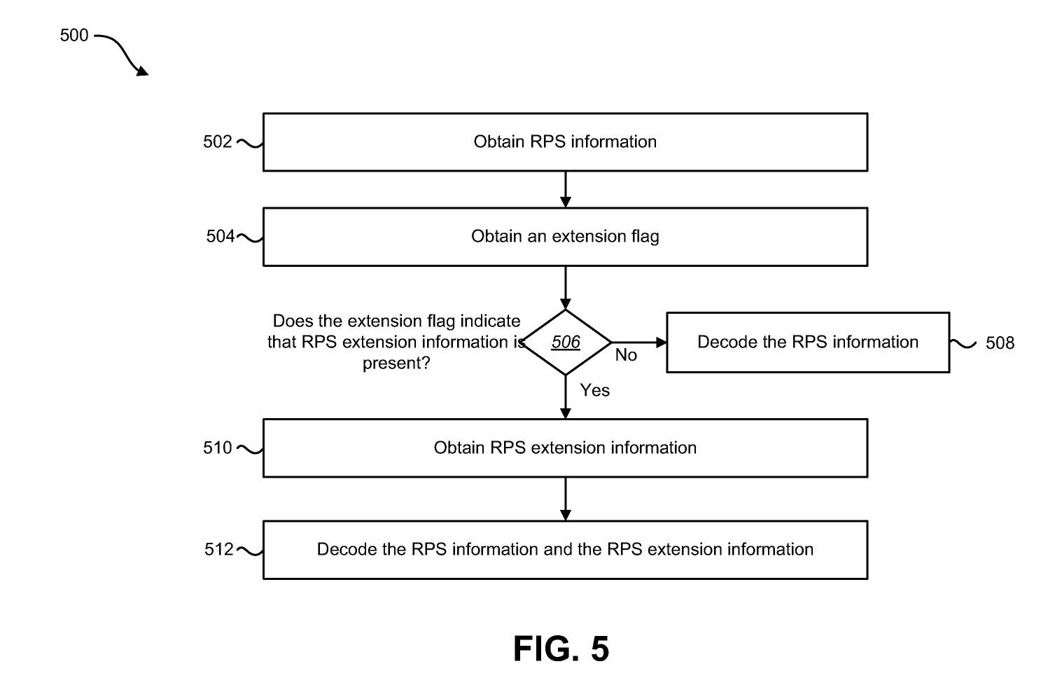

FIG. 5 is a flow diagram illustrating a more detailed configuration of a method 500 for receiving information by an electronic device 102. The electronic device 102 may obtain 502 RPS information and may obtain 504 an extension flag as described above in connection with FIG. 3.

The electronic device 102 may determine 506 whether RPS extension information is present based on the extension flag. For example, the decoder 112 may assess the extension flag in order to determine 506 whether RPS extension information may be present in the bitstream 110. In one configuration, a rps_extension_flag equal to 0 may indicate that RPS extension information is not present, while a rps_extension_flag equal to 1 may indicate that RPS extension information is present.

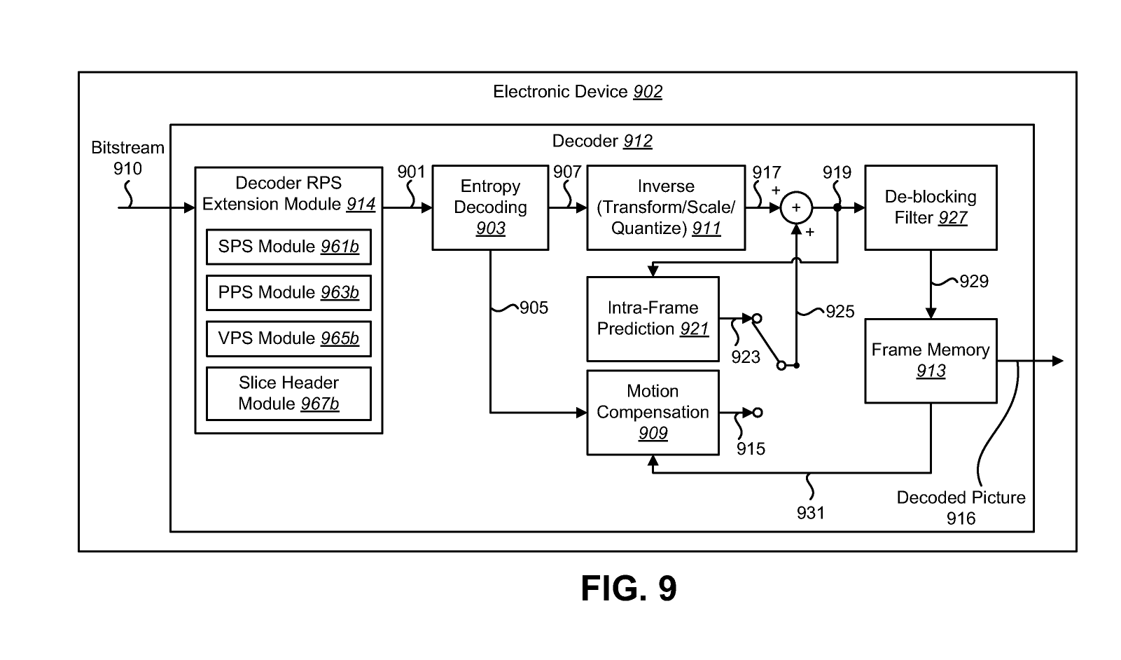

The electronic device 102 may decode 508 the RPS information if the electronic device 102 determines 506 that the extension flag does not indicate that RPS extension information is present. For example, if rps_extension_flag equals 0, the decoder 112 may decode 508 and use the RPS information as described in connection with one or more of FIG. 1 and FIG. 9 in order to produce a decoded picture 116.

The electronic device 102 may obtain 510 RPS extension information if the electronic device 102 determines 506 that the extension flag indicates that RPS extension information is present. For example, if rps_extension_flag equals 1, the decoder 112 may obtain 510 the RPS extension information from the bitstream 110. The decoder 112 may obtain 510 the RPS extension information from the bitstream 110 as described above in connection with FIG. 3.

The electronic device 102 may obtain 510 RPS extension information for one or more of the reference pictures that may be signaled by the RPS information. For example, the RPS extension information may include a layer identifier (e.g., layer_id) for each picture in a RPS. Alternatively, the RPS extension information may include a layer identifier for one or more selected pictures in a RPS.

Upon obtaining 510 the RPS extension information, the electronic device 102 may decode 512 the RPS information and RPS extension information. For example, the decoder 112 may decode 512 and use the RPS information and RPS extension information as described in connection with one or more of FIG. 1 and FIG. 9 in order to produce a decoded picture 116.

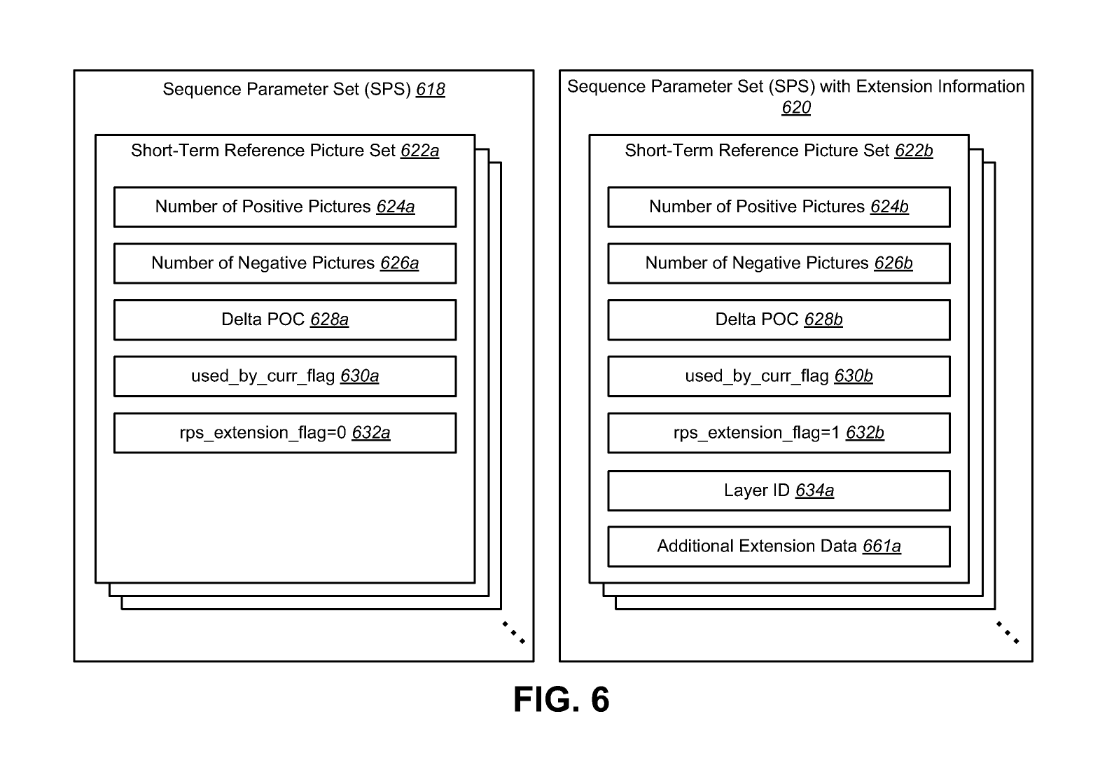

FIG. 6 is a block diagram illustrating two examples of sequence parameter sets 618, 620 in accordance with the systems and methods disclosed herein. In one configuration, a SPS extension may signal RPS extension syntax elements. For example, instead of signaling the RPS extension syntax elements defined in rps_extension( ) as a part of a RPS extension RBSP, the RPS extension syntax elements may be signaled as a part of a sps_extension RBSP (and/or as a part of slice_header_extension RBSP, for example). In this case, RPS extension syntax elements may be signaled by setting a sps_extension_flag equal to 1 (and/or by setting a slice_header_extension_present_flag equal to 1, for example). An example of signaling RPS extension syntax elements in this manner is illustrated in Table 9. This example may be used when signaling num_short_ref pic_sets reference picture sets in SPS.

TABLE 9

```
...
  bit_equal_to_one
for( j= 0; j < num_short_term_ref_pic_sets; j++)
  rps_extension(j)
  sps_extension_flag
  if( sps_extension_flag )
    while( more_rbsp_data( ) )
      sps_extension_data_flag
rbsp_trailing_bits( )
}
```

In some configurations, the rps_extension(j) may be implemented as illustrated in Table 10.

TABLE 10

```
rps_extension(j) {
  for( i = 0; i < num_negatiye_pics[j]; i++ ) {
    layer_id_s0[i]
  }
  for( i = 0; i < num_positiye_pics[j]; i++) {
    layer_id_s1[i]
  }
}
```

The two examples depicted in FIG. 6 illustrate how a SPS may signal RPS extension syntax elements. In one example, a SPS 618 may signal RPS information when RPS extension information is not present. The SPS 618 may include one or more short-term reference picture sets 622a. Each short-term reference picture set 622a may include RPS information. For instance, the short-term reference picture sets 622a may include a number of positive pictures 624a (e.g., num_positive_pics), a number of negative pictures 626a (e.g., num_negative_pics), a delta POC 628a and a used_by_curr_flag 630a. The short-term reference picture sets 622a may additionally include a RPS extension flag 632a (e.g., rps_extension_flag). In the example illustrated by SPS 618, the rps_extension_flag equals 0 in order to indicate that RPS extension information is not present.

In another example, a SPS with extension information (e.g., data) 620 may signal RPS information and RPS extension information when RPS extension information is present. The SPS with extension information 620 may include one or more short-term reference picture sets 622b. Each short-term reference picture set 622b may include RPS information and RPS extension information. For instance, the short-term reference picture sets 622b may include a number of positive pictures 624b, a number of negative pictures 626b, a delta POC 628b and a used_by_curr_flag 630b. The short-term reference picture sets 622b may additionally include a RPS extension flag 632b, which may equal 1 in order to indicate that RPS extension information is present. The short-term reference picture sets 622b may also include RPS extension information, which may include one or more of a layer identifier (e.g., layer ID 634a) and additional extension data 661a. The additional extension data 661a may include other data that may help in identifying and/or locating a picture as one of the pictures in the decoded picture buffer.

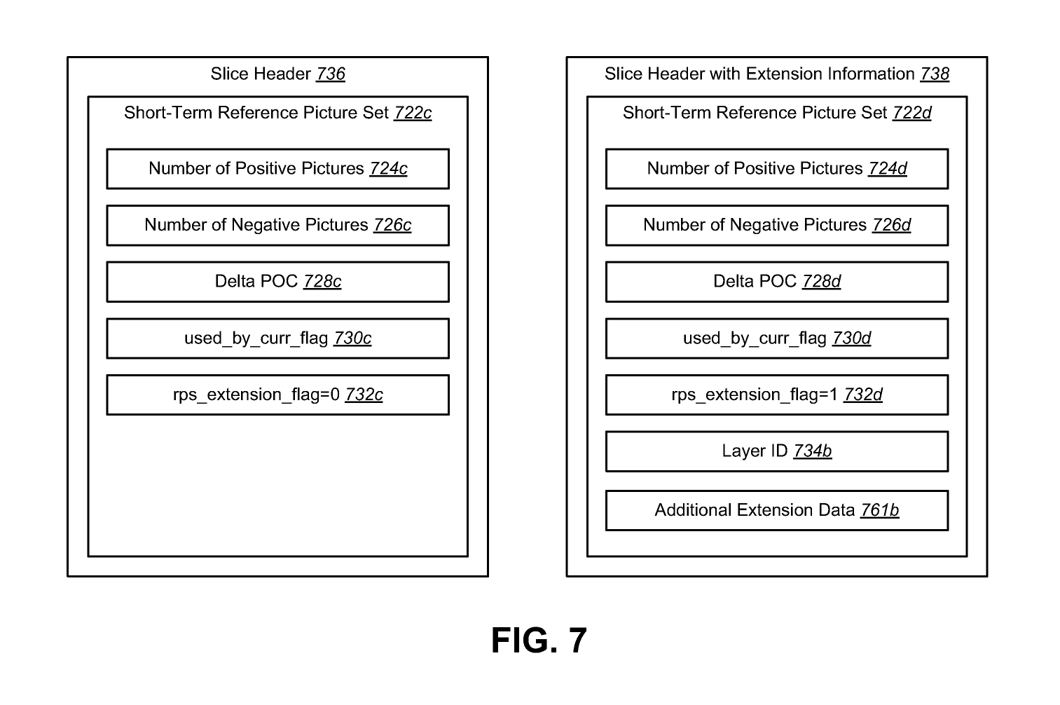

FIG. 7 is a block diagram illustrating two examples of slice headers 736, 738 in accordance with the systems and methods disclosed herein. In one configuration, a slice header extension may signal RPS extension syntax elements. For example, instead of signaling the RPS extension syntax elements defined in rps_extension( ) as a part of RPS extensions RBSP, the RPS extension syntax elements may be signaled as a part of a slice_header_extension RBSP. In this case, RPS extension syntax elements would be signaled by setting a slice_header_extension_present_flag equal to 1 in PPS. This approach may be used when signaling an explicit reference picture set (e.g., short_term_ref pic_set(num_short_term_ref pic_sets)) in a slice header. The rps_extension( ) syntax elements may then be signaled in the slice header as a part of slice_header_extension data.

The two examples depicted in FIG. 7 illustrate how a slice header may signal RPS extension syntax elements. In one example, a slice header 736 may signal RPS information when RPS extension information is not present. The slice header 736 may include a short-term reference picture set 722c. The short-term reference picture set 722c may include RPS information. For instance, the short-term reference picture set 722c may include a number of positive pictures 724c (e.g., num_positive_pics), a number of negative pictures 726c (e.g., num_negative_pics), a delta POC 728c and a used_by_curr_flag 730c. The short-term reference picture set 722c may additionally include a RPS extension flag 732c (e.g., rps_extension_flag). In the example illustrated by the slice header 736, the rps_extension_flag 732c equals 0 in order to indicate that RPS extension information is not present.

In another example, a slice header with extension information (e.g., data) 738 may signal RPS information and RPS extension information when RPS extension information is present. The slice header with extension information 738 may include a short-term reference picture set 722d. The short-term reference picture set 722d may include RPS information and RPS extension information. For instance, the short-term reference picture set 722d may include a number of positive pictures 724d, a number of negative pictures 726d, a delta POC 728d and a used_by_curr_flag 730d. The short-term reference picture set 722d may additionally include a RPS extension flag 732d, which may equal 1 in order to indicate that RPS extension information is present. The short-term reference picture set 722d may also include RPS extension information, which may include one or more of a layer identifier (e.g., layer ID 734b) and additional extension data 761a. The additional extension data 761a may include other data that may help in identifying and/or locating a picture as one of the pictures in the decoded picture buffer.

In addition to signaling the RPS extension syntax elements defined in rps_extension( ) as a part of a SPS extension RBSP or a slice header extension RBSP, the RPS extension syntax elements may be signaled as a part of a VPS extension RBSP and/or PPS extension RBSP in some configurations. In other cases, RPS extension syntax elements may be carried in some other normative part of the bistream 110. In the case of a VPS extension RBSP, a vps_extension_flag may be set to 1. Additionally or alternatively, in the case of a PPS extension RBSP, a pps_extension_flag may be set equal to 1.

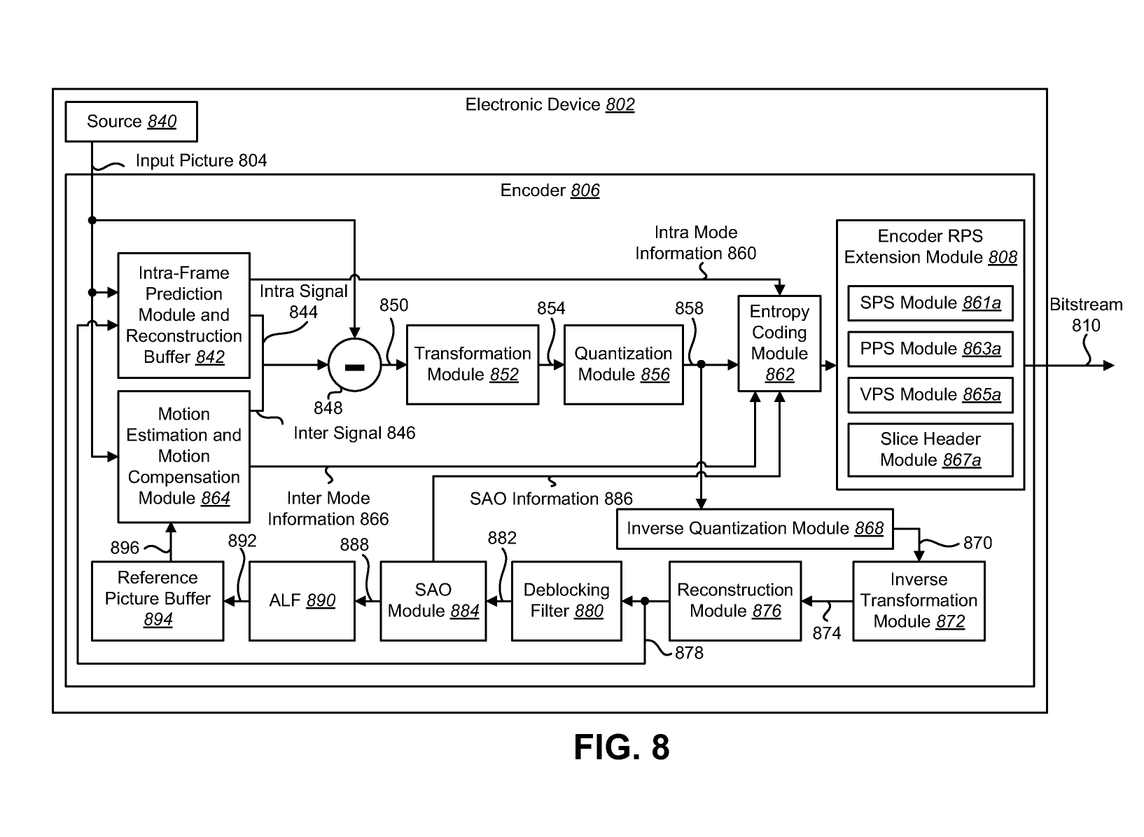

FIG. 8 is a block diagram illustrating one configuration of an encoder 806 on an electronic device 802. It should be noted that one or more of the elements illustrated as included within the electronic device 802 may be implemented in hardware, software or a combination of both. For example, the electronic device 802 includes an encoder 806, which may be implemented in hardware, software or a combination of both. For instance, the encoder 806 may be implemented as a circuit, integrated circuit, ASIC, processor in electronic communication with memory with executable instructions, firmware, field-programmable gate array (FPGA), etc., or a combination thereof. In some configurations, the encoder 806 may be a HEVC coder.

The electronic device 802 may include a source 840. The source 840 may provide picture or image data (e.g., video) as an input picture 804 to the encoder 806. Examples of the source 840 may include image sensors, memory, communication interfaces, network interfaces, wireless receivers, ports, etc.

One or more input pictures 804 may be provided to an intra-frame prediction module and reconstruction buffer 842. An input picture 804 may also be provided to a motion estimation and motion compensation module 864 and to a subtraction module 848.

The intra-frame prediction module and reconstruction buffer 842 may generate intra mode information 860 and an intra signal 844 based on one or more input pictures 804 and reconstructed data 878. The motion estimation and motion compensation module 864 may generate inter mode information 866 and an inter signal 846 based on one or more input pictures 804 and a reference picture buffer 894 signal 896. In some configurations, the reference picture buffer 894 may include data from one or more reference pictures in the reference picture buffer 894.

The encoder 806 may select between the intra signal 844 and the inter signal 846 in accordance with a mode. The intra signal 844 may be used in order to exploit spatial characteristics within a picture in an intra coding mode. The inter signal 846 may be used in order to exploit temporal characteristics between pictures in an inter coding mode. While in the intra coding mode, the intra signal 844 may be provided to the subtraction module 848 and the intra mode information 860 may be provided to an entropy coding module 862. While in the inter coding mode, the inter signal 846 may be provided to the subtraction module 848 and the inter mode information 866 may be provided to the entropy coding module 862.

Either the intra signal 844 or the inter signal 846 (depending on the mode) is subtracted from an input picture 804 at the subtraction module 848 in order to produce a prediction residual 850. The prediction residual 850 is provided to a transformation module 852. The transformation module 852 may compress the prediction residual 850 to produce a transformed signal 854 that is provided to a quantization module 856. The quantization module 856 quantizes the transformed signal 854 to produce transformed and quantized coefficients (TQCs) 858.

The TQCs 858 are provided to an entropy coding module 862 and an inverse quantization module 868. The inverse quantization module 868 performs inverse quantization on the TQCs 858 to produce an inverse quantized signal 870 that is provided to an inverse transformation module 872. The inverse transformation module 872 decompresses the inverse quantized signal 870 to produce a decompressed signal 874 that is provided to a reconstruction module 876.

The reconstruction module 876 may produce reconstructed data 878 based on the decompressed signal 874. For example, the reconstruction module 876 may reconstruct (modify) pictures. The reconstructed data 878 may be provided to a deblocking filter 880 and to the intra-frame prediction module and reconstruction buffer 842. The deblocking filter 880 may produce a filtered signal 882 based on the reconstructed data 878.

The filtered signal 882 may be provided to a sample adaptive offset (SAO) module 884. The SAO module 884 may produce SAO information 886 that is provided to the entropy coding module 862 and an SAO signal 888 that is provided to an adaptive loop filter (ALF) 890. The ALF 890 produces an ALF signal 892 that is provided to the reference picture buffer 894. The ALF signal 892 may include data from one or more pictures that may be used as reference pictures.

The entropy coding module 862 may code the TQCs 858 to produce a bitstream 810 or other signal. Also, the entropy coding module 862 may code the TQCs 858 using Context-Adaptive Variable Length Coding (CAVLC) or Context-Adaptive Binary Arithmetic Coding (CABAC). In particular, the entropy coding module 862 may code the TQCs 858 based on one or more of intra mode information 860, inter mode information 866 and SAO information 886. In some configurations, the bitstream 810 may include coded picture data. In one example, the bitstream 810 is passed to an encoder RPS extension module 808 prior to being sent from the encoder 806 or to another electronic device 802.

Quantization, involved in video compression such as HEVC, is a lossy compression technique achieved by compressing a range of values to a single quantum value. The quantization parameter (QP) is a predefined scaling parameter used to perform the quantization based on both the quality of reconstructed video and compression ratio. The block type is defined in HEVC to represent the characteristics of a given block based on the block size and its color information. QP, resolution information and block type may be determined before entropy coding. For example, the electronic device 802 (e.g., the encoder 806) may determine the QP, resolution information and block type, which may be provided to the entropy coding module 862.

The entropy coding module 862 may determine the block size based on a block of TQCs 858. For example, block size may be the number of TQCs 858 along one dimension of the block of TQCs. In other words, the number of TQCs 858 in the block of TQCs may be equal to block size squared. For instance, block size may be determined as the square root of the number of TQCs 858 in the block of TQCs. Resolution may be defined as a pixel width by a pixel height. Resolution information may include a number of pixels for the width of a picture, for the height of a picture or both. Block size may be defined as the number of TQCs 858 along one dimension of a 2D block of TQCs.

In some configurations, the entropy coding module 862 sends a bitstream 810 or other signal including one or more pictures to an encoder RPS extension module 808. The encoder RPS extension module 808 may determine whether to signal RPS extension information and may create RPS extension information (e.g., Layer ID 634a) if it is determined to signal RPS extension information. The encoder RPS extension module 808 may additionally or alternatively generate an extension flag that indicates the presence of RPS extension information. In some cases the encoder RPS extension module 808 may be together with or be part of a high level syntax (HLS) module.

The encoder RPS extension module 808 may include a variety of modules or sub-modules for creating RPS extension information. For example, the encoder RPS extension module 808 may include one or more of a SPS module 861a, PPS module 863a, VPS module 865a, slice header module 867a and other modules for creating RPS extension information.

The encoder RPS extension module 808 may create RPS extension information and may additionally or alternatively generate a flag (e.g., one or more of a RPS extension flag 632 and STPRS extension flag) or other indicator to indicate whether RPS extension information is present. For example, the SPS module 861a, PPS module 863a, VPS module 865a, slice header module 867a or other module may create RPS extension information. The SPS module 861a, PPS module 863a, VPS module 865a, slice header module 867a or other module may additionally or alternatively generate one or more RPS extension flags 632 to indicate whether or not RPS extension information is present in a bitstream 810 of data. For instance, the SPS module 861a may create RPS extension information and/or generate a flag in a SPS to correspond to the presence of RPS extension information. In another example, the PPS module 863a may create RPS extension information and/or generate a flag or other indicator in a PPS to correspond to the presence of RPS extension information. In another example, the VPS module 865a may create RPS extension information and/or generate a flag in a VPS to correspond to the presence of RPS extension information. In another example, the slice header module 867a may create RPS extension information and generate a flag or other indicator in a slice header to correspond to the presence or absence of RPS extension information.

In some configurations, one or more of the modules described herein may generate one or more flags corresponding to RPS extension information. Further, the encoder RPS extension module 808 may modify or create the RPS extension flag 632 to accompany or send with a bitstream 810 of data to be stored on the electronic device 802 or be sent to another electronic device (e.g., 102b).

In some configurations, the bitstream 810 may be transmitted to another electronic device (e.g., 102b). For example, the bitstream 810 may be provided to a communication interface, network interface, wireless transmitter, port, etc. For instance, the bitstream 810 may be transmitted to another electronic device via LAN, the Internet, a cellular phone base station, etc. The bitstream 810 may additionally or alternatively be stored in memory or other component on the electronic device 802.

FIG. 9 is a block diagram illustrating one configuration of a decoder 912 on an electronic device 902. The decoder 912 may be included in an electronic device 902. For example, the decoder 912 may be a HEVC decoder. The decoder 912 and/or one or more of the elements illustrated as included in the decoder 912 may be implemented in hardware, software or a combination of both. The decoder 912 may receive a bitstream 910 (e.g., one or more encoded pictures included in the bitstream 910) for decoding. In some configurations, the received bitstream 910 may include received overhead information, such as a SPS, VPS, PPS, slice header, received buffer description information, etc. The encoded pictures included in the bitstream 910 may include one or more encoded reference pictures, reference picture sets and/or one or more other encoded pictures. In some configurations, the bitstream 910 may include or be accompanied by RPS information, RPS extension information and/or one or more extension flags.

In one configuration, the decoder 912 may include a decoder RPS extension module 914. In some configurations, the electronic device 902 receives a bitstream 910 and sends the bitstream 910 through the decoder RPS extension module 914. The decoder RPS extension module 914 may be part of a decoder 912 or other component on the electronic device 902. In some configurations, the decoder RPS extension module 914 may determine whether RPS extension information is present. This may be based on an extension flag (e.g., rps_extension_flag 632a-b) included in the bitstream 910. In some cases, the decoder RPS extension module 914 may be together with (e.g., coupled to) or may be part of a high level syntax (HLS) module.

The decoder RPS extension module 914 may include a variety of modules or sub-modules for determining whether RPS extension information is present based on whether a bitstream 910 includes an extension flag. For example, the decoder RPS extension module 914 may include a SPS module 961b, PPS module 963b, VPS module 965b, slice header module 967b and/or other module for determining whether RPS extension information is accompanying or included in a bitstream 910. In some configurations, the decoder RPS extension module 914 may receive the bitstream 910 prior to passing decoded RPS information and/or decoded RPS extension information 901 through certain elements of the decoder 912. In another configuration, the extension information that is output from the decoder RPS extension module 914 may be provided to the frame memory 913 (e.g., a DPB).

The extension information may be used by the decoder 912 to correctly identify and locate which reference picture in the frame memory 913 (e.g., DPB) is signaled in the RPS. In one example, the extended information consists of layer identifier (e.g., layer_id) information for the reference pictures. In this case, the layer identifier (e.g., layer_id) information, together with the delta_poc information, is used to locate the correct reference picture in the frame memory (e.g., DPB). For example, there may be more than one picture in the frame memory 913 (e.g., DPB) that has the same POC value but different layer identifier (e.g., layer_id) values.

In some configurations, one or more of the decoder RPS extension module 914 modules or sub-modules may determine whether RPS extension information is present based on varying types of indicators. For example, the SPS module 961b may determine whether a flag or indicator associated with the SPS is present with the bitstream 910. The PPS module 963b may determine whether a flag or indicator associated with the PPS is present with the bitstream 910. The VPS module 965b may determine whether a flag or indicator associated with the VPS is present with the bitstream 910. The slice header module 967b may determine whether a flag or indicator associated with a slice header of a picture is present with the bitstream 910.

Received symbols (in the one or more encoded pictures included in the bitstream 910) may be entropy decoded by an entropy decoding module 903, thereby producing a motion information signal 905 and quantized, scaled and/or transformed coefficients 907.

The motion information signal 905 may be combined with a portion of a reference frame signal 931 from a frame memory 913 at a motion compensation module 909, which may produce an inter-frame prediction signal 915. The quantized, descaled and/or transformed coefficients 907 may be inverse quantized, scaled and inverse transformed by an inverse module 911, thereby producing a decoded residual signal 917. The decoded residual signal 917 may be added to a prediction signal 925 to produce a combined signal 919. The prediction signal 925 may be a signal selected from the inter-frame prediction signal 915 produced by the motion compensation module 909 or alternatively the intra-frame prediction signal 923 produced by an intra-frame prediction module 921. In some configurations, this signal selection may be based on (e.g., controlled by) the bitstream 910.

The intra-frame prediction signal 923 may be predicted from previously decoded information from the combined signal 919 (in the current frame, for example). The combined signal 919 may also be filtered by a de-blocking filter 927. The resulting filtered signal 929 may be written to frame memory 913. The resulting filtered signal 929 may include a decoded picture 916.

The frame memory 913 may include overhead information corresponding to the decoded pictures 916. For example, the frame memory 913 may include slice headers, PPS information, cycle parameters, buffer description information, etc. One or more of these pieces of information may be signaled from an encoder (e.g., encoder 806). The frame memory 913 may provide a decoded picture 916 or other output signal.

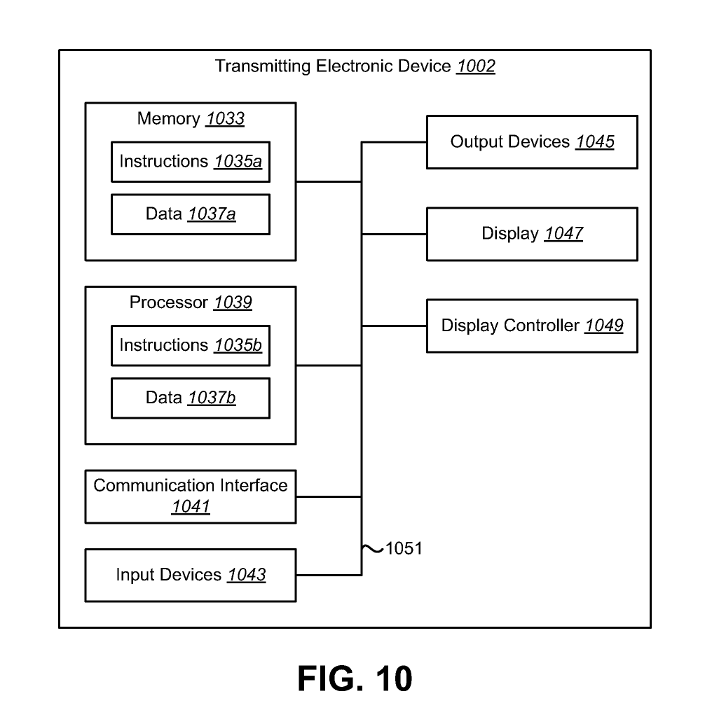

FIG. 10 illustrates various components that may be utilized in a transmitting electronic device 1002. One or more of the electronic devices 102, 802, 902, 1102, 1202 and 1302 described herein may be implemented in accordance with the transmitting electronic device 1002 illustrated in FIG. 10.

The transmitting electronic device 1002 includes a processor 1039 that controls operation of the transmitting electronic device 1002. The processor 1039 may also be referred to as a central processing unit (CPU). Memory 1033, which may include both read-only memory (ROM), random access memory (RAM) or any type of device that may store information, provides instructions 1035a (e.g., executable instructions) and data 1037a to the processor 1039. A portion of the memory 1033 may also include non-volatile random access memory (NVRAM). The memory 1033 may be in electronic communication with the processor 1039.

Instructions 1035b and data 1037b may also reside in the processor 1039. Instructions 1035b and/or data 1037b loaded into the processor 1039 may also include instructions 1035a and/or data 1037a from memory 1033 that were loaded for execution or processing by the processor 1039. The instructions 1035b may be executed by the processor 1039 to implement one or more of the methods 200, 300, 400, 500 disclosed herein.

The transmitting electronic device 1002 may include one or more communication interfaces 1041 for communicating with other electronic devices (e.g., receiving electronic device). The communication interfaces 1041 may be based on wired communication technology, wireless communication technology, or both. Examples of a communication interface 1041 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The transmitting electronic device 1002 may include one or more output devices 1045 and one or more input devices 1043. Examples of output devices 1045 include a speaker, printer, etc. One type of output device that may be included in a transmitting electronic device 1002 is a display device 1047. Display devices 1047 used with configurations disclosed herein may utilize any suitable image projection technology, such as a cathode ray tube (CRT), liquid crystal display (LCD), light-emitting diode (LED), gas plasma, electroluminescence or the like. A display controller 1049 may be provided for converting data stored in the memory 1033 into text, graphics, and/or moving images (as appropriate) shown on the display 1047. Examples of input devices 1043 include a keyboard, mouse, microphone, remote control device, button, joystick, trackball, touchpad, touchscreen, lightpen, etc.

The various components of the transmitting electronic device 1002 are coupled together by a bus system 1051, which may include a power bus, a control signal bus and a status signal bus, in addition to a data bus. However, for the sake of clarity, the various buses are illustrated in FIG. 10 as the bus system 1051. The transmitting electronic device 1002, illustrated in FIG. 10, is a functional block diagram rather than a listing of specific components.

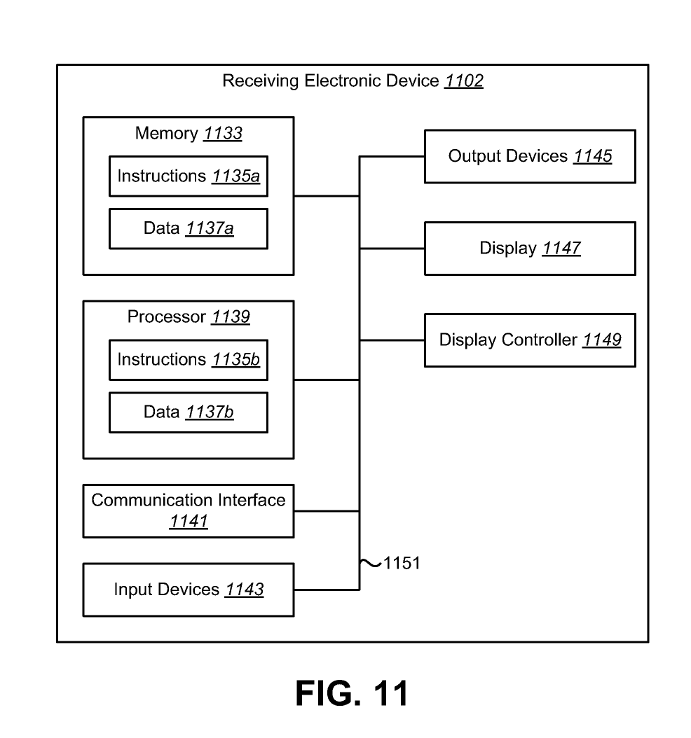

FIG. 11 is a block diagram illustrating various components that may be utilized in a receiving electronic device 1102. One or more of the electronic devices 102, 802, 902, 1002, 1202 and 1302 may be implemented in accordance with the receiving electronic device 1102 illustrated in FIG. 11.

The receiving electronic device 1102 includes a processor 1139 that controls operation of the receiving electronic device 1102. The processor 1139 may also be referred to as a CPU. Memory 1133, which may include both ROM, RAM or any type of device that may store information, provides instructions 1135a (e.g., executable instructions) and data 1137a to the processor 1139. A portion of the memory 1133 may also include NVRAM. The memory 1133 may be in electronic communication with the processor 1139.

Instructions 1135b and data 1137b may also reside in the processor 1139. Instructions 1135b and/or data 1137b loaded into the processor 1139 may also include instructions 1135a and/or data 1137a from memory 1133 that were loaded for execution or processing by the processor 1139. The instructions 1135b may be executed by the processor 1139 to implement one or more of the methods 200, 300, 400, 500 disclosed herein.

The receiving electronic device 1102 may include one or more communication interfaces 1141 for communicating with other electronic devices (e.g., a transmitting electronic device). The communication interfaces 1141 may be based on wired communication technology, wireless communication technology, or both. Examples of a communication interface 1141 include a serial port, a parallel port, a USB, an Ethernet adapter, an IEEE 1394 bus interface, a SCSI bus interface, an IR communication port, a Bluetooth wireless communication adapter, a wireless transceiver in accordance with 3GPP specifications and so forth.

The receiving electronic device 1102 may include one or more output devices 1145 and one or more input devices 1143. Examples of output devices 1145 include a speaker, printer, etc. One type of output device that may be included in a receiving electronic device 1102 is a display device 1147. Display devices 1147 used with configurations disclosed herein may utilize any suitable image projection technology, such as a CRT, LCD, LED, gas plasma, electroluminescence or the like. A display controller 1149 may be provided for converting data stored in the memory 1133 into text, graphics, and/or moving images (as appropriate) shown on the display 1147. Examples of input devices 1143 include a keyboard, mouse, microphone, remote control device, button, joystick, trackball, touchpad, touchscreen, lightpen, etc.

The various components of the receiving electronic device 1102 are coupled together by a bus system 1151, which may include a power bus, a control signal bus and a status signal bus, in addition to a data bus. However, for the sake of clarity, the various buses are illustrated in FIG. 11 as the bus system 1151. The receiving electronic device 1102 illustrated in FIG. 11 is a functional block diagram rather than a listing of specific components.

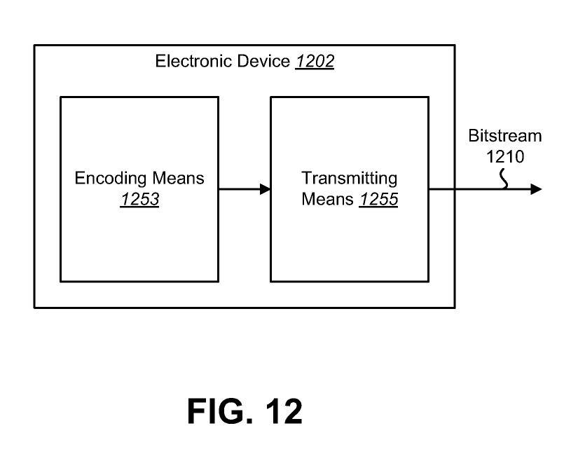

FIG. 12 is a block diagram illustrating one configuration of an electronic device 1202 in which systems and methods for reference picture set extension may be implemented. The electronic device 1202 may include encoding means 1253 and transmitting means 1255. The electronic device 1202 may generate a bitstream 1210. The encoding means 1253 and transmitting means 1255 may be configured to perform one or more functions described in connection with one or more of FIG. 2, FIG. 4 and other Figures described herein. FIG. 10 illustrates one example of a concrete apparatus structure of FIG. 12. Other various structures may be implemented to realize one or more of the functions of FIG. 1 and FIG. 8. For example, one or more of the functions of FIG. 1 and FIG. 8 may be realized by a processor.

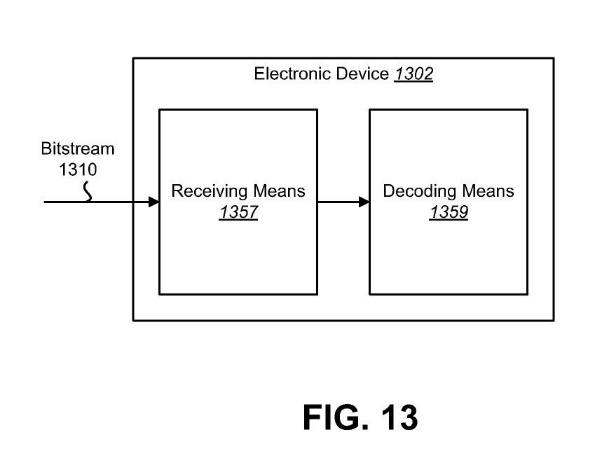

FIG. 13 is a block diagram illustrating another configuration of an electronic device 1302 in which systems and methods for reference picture set extension may be implemented. The electronic device 1302 may include receiving means 1357 and decoding means 1359. The electronic device 1302 may receive a bitstream 1310. The receiving means 1357 and decoding means 1359 may be configured to perform one or more of the functions described in connection with FIG. 3, FIG. 5 and other Figures described herein. FIG. 11 above illustrates one example of a concrete apparatus structure of FIG. 13. Other various structures may be implemented to realize one or more functions of FIG. 1 and FIG. 9. For example, one or more functions of FIG. 1 and FIG. 9 may be realized by a processor.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an ASIC, a LSI or integrated circuit, etc.

Each of the methods disclosed herein comprises one or more steps or actions for achieving the described method. The method steps and/or actions may be interchanged with one another and/or combined into a single step without departing from the scope of the claims In other words, unless a specific order of steps or actions is required for proper operation of the method that is being described, the order and/or use of specific steps and/or actions may be modified without departing from the scope of the claims

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for sending information by an electronic device, comprising:
creating reference picture set (RPS) information based on a coding structure;
determining whether to signal RPS extension information;
creating the RPS extension information if it is determined to signal RPS extension information; and
sending the RPS extension information if it is determined to signal RPS extension information.

2. The method of claim 1, further comprising generating an extension flag, wherein the extension flag indicates the presence of the RPS extension information if it is determined to signal RPS extension information, wherein the extension flag is at least one of an RPS extension flag and a short-term reference picture set (STRPS) extension flag.

3. The method of claim 1, wherein the RPS extension information comprises one or more layer identifiers.

4. The method of claim 3, wherein the RPS extension information includes a layer identifier for each picture in a reference picture set.

5. The method of claim 4, wherein the RPS extension information includes a layer identifier for one or more selected pictures in a reference picture set.

6. The method of claim 1, wherein the signal and the RPS extension information are sent in at least one of a Sequence Parameter Set (SPS), a Video Parameter Set (VPS), a Picture Parameter Set (PPS), a slice header and other normative part of a bitstream.

7. A method for receiving information by an electronic device, comprising:
obtaining reference picture set (RPS) information;
obtaining an extension flag;
determining whether RPS extension information is present based on the extension flag; and
obtaining RPS extension information if RPS extension information is present.

8. The method of claim 7, wherein the RPS extension information comprises one or more layer identifiers.

9. The method of claim 8, wherein the RPS extension information includes a layer identifier for each picture in a reference picture set.

10. The method of claim 8, wherein the RPS extension information includes a layer identifier for one or more selected pictures in a reference picture set.

11. The method of claim 7, wherein the extension flag is included in at least one of a Sequence Parameter Set (SPS), a Video Parameter Set (VPS), a Picture Parameter Set (PPS), a slice header and other normative part of a bitstream.

12. The method of claim 7, wherein the RPS extension information is included in at least one of a Sequence Parameter Set (SPS), a Video Parameter Set (VPS), a Picture Parameter Set (PPS), a slice header and other normative part of a bitstream.

13. An electronic device for sending information, comprising:
a processor;
memory in electronic communication with the processor, wherein instructions stored in the memory are executable to:
create reference picture set (RPS) information based on a coding structure;
determine whether to signal RPS extension information;
create the RPS extension information if it is determined to signal RPS extension information; and
send the RPS extension information if it is determined to signal RPS extension information.

14. The electronic device of claim 13, wherein the instructions are further executable to generate an extension flag, wherein the extension flag indicates the presence of the RPS extension information if it is determined that the RPS extension information is to be signaled, wherein the extension flag is at least one of an RPS extension flag and a short-term reference picture set (STRPS) extension flag.

15. The electronic device of claim 13, wherein the RPS extension information comprises one or more layer identifiers.

16. The electronic device of claim 15, wherein the RPS extension information includes a layer identifier for each picture in a reference picture set.

17. The electronic device of claim 15, wherein the RPS extension information includes a layer identifier for one or more selected pictures in a reference picture set.

18. The electronic device of claim 13, wherein the signal and the RPS extension information are sent in at least one of a Sequence Parameter Set (SPS), a Video Parameter Set (VPS), a Picture Parameter Set (PPS), a slice header and other normative part of a bitstream.

19. An electronic device for receiving information, comprising:
a processor;
memory in electronic communication with the processor, wherein instructions stored in the memory are executable to:
obtain reference picture set (RPS) information;
obtain an extension flag;
determine whether RPS extension information is present based on the extension flag; and
obtain RPS extension information if RPS extension information is present.

20. The electronic device of claim 19, wherein the RPS extension information comprises one or more layer identifiers.

21. The electronic device of claim 20, wherein the RPS extension information includes a layer identifier for each picture in a reference picture set.

22. The electronic device of claim 20, wherein the RPS extension information includes a layer identifier for one or more selected pictures in a reference picture set.

23. The electronic device of claim 19, wherein the extension flag is included in at least one of a Sequence Parameter Set (SPS), a Video Parameter Set (VPS), a Picture Parameter Set (PPS), a slice header and other normative part of a bitstream.

24. The electronic device of claim 19, wherein the RPS extension information is included in at least one of a Sequence Parameter Set (SPS), a Video Parameter Set (VPS), a Picture Parameter Set (PPS), a slice header and other normative part of a bitstream.
